(19) United States
(12) Patent Application Publication
(10) Pub. No.: US 2012/0147611 A1
(43) Pub. Date: Jun. 14, 2012

(54) LIGHT EMITTING DIODE-BASED LAMP HAVING A VOLUME SCATTERING ELEMENT

(75) Inventors: Michelle Huang, Manchester, MA (US); Junwon Lee, Peabody, MA (US); Tom Spehalski, Emporium, PA (US); Fernando Ulloa, Danvers, MA (US)

(73) Assignee: OSRAM SYLVANIA, INC., Danvers, MA (US)

(21) Appl. No.: 13/362,044

(22) Filed: Jan. 31, 2012

Related U.S. Application Data
(62) Division of application No. 12/351,197, filed on Jan. 9, 2009, now abandoned.
(60) Provisional application No. 61/105,980, filed on Oct. 16, 2008.

(51) Int. Cl. F21V 29/00; F21V 35/00

(52) U.S. Cl. 362/392

(57) ABSTRACT

A lamp having a candle-like appearance and using one or more light-emitting diodes (LEDs) as its light source is presented. The candle-like appearance arises because light is emitted from only a small volume at or near the center of the bulb. The heat sink and control electronics are located outside the bulb of the lamp. Inside the bulb is a set of secondary optics that guide the light from one or more LEDs to an emission point at a prescribed location in the interior of the bulb. The secondary optics include a light pipe that guides light away from the LED chip, and a volume scattering element that receives the light from the light pipe and scatters it into various directions. The volume scattering element is made from a transparent base material, and includes transparent particles of a predetermined size and refractive index. Because the lamp is typically used in an overhead position, such as in a hanging chandelier, the density of particles in the volume scattering element, the particle size and the particle refractive index are chosen to produce a scattering pattern that directs more light downward (toward the base of the bulb) than upward, while maintaining a reasonable efficiency (fraction of produced light that successfully exits the lamp). Simulation results are presented.

### CROSS-REFERENCE TO RELATED APPLICATIONS

The present application is a divisional application of U.S. patent application Ser. No. 12/351,197, filed on Jan. 9, 2009 under the same title, which claims priority under 35 U.S.C §119(e) to provisional application No. 61/105,980, filed on Oct. 16, 2008 under the same title. Full Paris Convention priority is hereby expressly reserved.

### STATEMENT REGARDING FEDERALLY SPONSORED RESEARCH OR DEVELOPMENT

Not Applicable

### BACKGROUND OF THE INVENTION

1. Field of the Invention

The present invention is directed to a light emitting diode-based lamp having a volume scattering element inside the bulb.

2. Description of the Related Art

Prior to the invention of the light bulb, candles were a stylish choice for fancy lighting. A chandelier would hang from the ceiling of a room, and would support several candles, often arranged in an ornate and decorative manner around the circumference of the chandelier.

When incandescent light bulbs became popular, many electric chandeliers emulated the look of the candle-holding chandeliers. Instead of a series of candles, these electric chandeliers had many long, columnar structures, each supporting a small light bulb that mimicked the candle flame.

The bulbs used in these chandeliers were stylishly shaped, often resembling the tall, thin shape of a candle flame. The light was produced by a relatively small filament inside the bulb, with thin wires supporting the filament and electrically connecting the filament to the electrical contacts in the threaded base of the bulb.

In recent years, light-emitting diodes (LEDs) have entered the lighting market. There have been some attempts to replace the stylish filament-based incandescent bulbs with similarly-shaped and sized bulbs that use one or more LEDs as their light source.

One such LED-based lamp 200 is shown in FIG. 19. The lamp 200 is commercially available from Cao Group, Inc., which is based in West Jordan, UT. The lamp 200 is currently sold under the brand name DYNASTY, which is a registered trademark of Cao Group, Inc. The specific lamp is sold as a “B10 LED Candelabra Lamp”. The “B10” refers to a bulb shape and size, with a maximum diameter of 1.26 inches (32.0 mm), a maximum overall length of 3.87 inches (98.3 mm), and a light center length (distance from the tip of the threads to the light emission point) of 2.17 inches (55.0 mm). The “Candelabra” refers to the base into which the lamp screws. The standard “Candelabra” base is also known as “E12”, so that the base cap of an “E12” lamp has a 12 mm diameter at the thread peaks. This particular lamp uses only 1.7 watts, compared to typical incandescent wattages of 25, 40 or 60 watts, so there is a considerable energy savings for the user.

The Dynasty lamp 200 has a glass outer bulb 201, an LED 202 located inside the bulb 201 at the light emission point, a heat sink 203 inside the bulb for dissipating the heat generated by the LED 202, and control electronics 204 inside the bulb for converting the line voltage (120 volts, AC) to a relatively low voltage (on the order of 5 volts, DC) and electrically powering the LED 202.

The Dynasty lamp 200 has many advantages over incandescent lamps. For instance, it uses very little power (1.7 watts), has a very long lifetime (35,000 hours, according to Cao Group, Inc.), and is backwards-compatible with many incandescent fixtures. However, there are several drawbacks to this lamp.

The primary drawback is that the lamp itself is cosmetically unappealing. The heat sink 203 is clearly visible through the bulb 201. The control electronics 204, although hidden by a shell, are also present within the bulb 201. Such structures detract from the overall appearance of the Dynasty lamp 200. Considering that its primary use is in stylish chandeliers, the Dynasty lamp 200 is an unattractive choice.

Another example of an LED-based lamp is commercially available from Watt-Man, which is based in Charlottesville, Va. The lamp is sold as the “Watt-Man LED Decor Lamp—B10”. The lamp has a 1.25 inch diameter and a 4.0 inch maximum overall length. The lamp is available in candelabra (E12) or medium (E26) base styles. The advantages and drawbacks of the Watt-Man lamp are similar to those of the Dynasty lamp 200 of FIG. 19.

Another known lamp is disclosed in U.S. Pat. No. 7,329,029, titled “Optical device for LED-based lamp”, and issued on Feb. 12, 2008 to Chaves et al. FIG. 20 of the present application is reproduced from FIG. 34A of Chaves.

Chaves discloses an optical element for receiving the light output from an LED and redirecting in into a predominantly spherical pattern. The element includes a so-called “transfer section” that receives the LED's light within it and a so-called “ejector section” positioned adjacent the transfer section to receive light from the transfer section and spread the light generally spherically. A base of the transfer section is optically aligned and/or coupled to the LED so that the LED's light enters the transfer section. The transfer section can be a compound elliptic concentrator operating via total internal reflection. The ejector section can have a variety of shapes.

FIG. 20 shows one of many optical element shapes disclosed by Chaves. The LEDs are shown as the small rectangles at the bottom of FIG. 20, and light emitted from the LEDs travels upward within the element 600, undergoing a variety of internal reflections and/or refractions, until it exits the element 600 near the top of the element 600. In the terminology of Chaves, FIG. 20 shows virtual filament 600 comprising equiangular-spiral transfer section 601 with center on opposite point 601f, protruding cubic spline 602, and central equiangular spiral 603 with center at proximal point 603f.

It is noteworthy that light rays inside the element 600 follow a deterministic path governed by Snell's Law (the refractive index times the sine of an angle made with a surface normal remains constant on both sides of an interface) and the Law of Refraction (the angle of incidence equals the angle of reflection, both made with a surface normal). This deterministic nature of the light propagation within the element 600 means has several drawbacks.

First, the element 600 has an optical axis, and requires fairly careful alignment to operate properly. If the LEDs are misaligned slightly away from their target positions, the light pattern within the element 600 shifts dramatically, with some exiting angles receiving more light and some exiting angles receiving less.

Second, because element 600 operates in a deterministic manner and relies on a generally smooth surface for its optimal operation, element 600 is especially vulnerable to defects. Specifically, surface defects, such as scratches, structure defects, such as size or shape errors, and material defects, such as refractive index variations or contamination, can seriously degrade the performance of the element 600.

There is another known lamp that has a similar deterministic characteristic to propagation within the element, but adds a surface diffuser to randomize the light ray output direction upon leaving the element. This lamp is disclosed in U.S. Pat. No. 7,021,797, titled “Optical device for repositioning and redistributing an LED's light”, and issued on Apr. 4, 2006 to Miriano et al. FIG. 21 of the present application is reproduced from FIG. 7A from Miriano.

In the known lamp of present FIG. 21, an LED directs light into a lens 270. Light enters the bottom of a transfer section 271, which contains the light via total internal reflection and directs it upward into an ejector section 272. The ejector section 272 has a diffuser on its surface, which can redirect light rays at its surface into a range of exiting angles out of the lens 270. The diffusive surface of ejector section 272 may be referred to as a “surface diffuser” or a “surface scatterer”, because any randomization of the light path occurs at only one point in the light path, at the diffuse surface itself.

The surface diffuser on the surface of the ejector has an advantage over Chaves in that it reduces the sensitivity to defects (the second drawback noted above). However, it still has the drawback that the deterministic propagation within the lens 270 creates a fairly tight alignment tolerance between the LEDs and the lens 270. If the LEDs are displaced away from their target positions, portions of the transfer section 272 become dimmer, and other portions become brighter.

A useful analogy to the surface diffuser is a frosted-glass light bulb, where the frosting of the glass directs the exiting light rays into a variety of angles. The deterministic propagation issues discussed above would have the effect of making portions of the bulb surface brighter or dimmer than other portions. This variation in brightness would be visible from a variety of angles, because of the glass frosting, but the surface diffuser would not mask the variations in brightness on the frosted bulb surface.

Accordingly, it would be beneficial to have an LED-based lamp, in which the heat sink and driver electronics are housed outside the bulb, only optical elements made from transparent materials are inside the bulb, and the optical performance shows an increased resistance to misalignment and manufacturing defects.

### BRIEF SUMMARY OF THE INVENTION

An embodiment is lamp, comprising: a transparent bulb enclosing a volume and having an opening at a longitudinal end; a light emitting diode disposed proximate the opening in the transparent bulb for emitting light into the transparent bulb; a transparent light pipe disposed inside the transparent bulb proximate the opening in the transparent bulb for receiving light from the light emitting diode, the light entering a proximal end of the light pipe and propagating longitudinally away from the proximal end to a distal end of the light pipe; and a volume scattering element disposed inside the transparent bulb adjacent to the distal end of the light pipe for receiving light from the transparent light pipe and for scattering light into a plurality of exiting angles. The scattered light exits the lamp through the transparent bulb. The volume scattering element comprises a transparent base material and a plurality of particles distributed throughout the base material. Each particle in the plurality is transparent and has a refractive index different than that of the base material.

Another embodiment is a method of providing light, comprising: locating a light emitting diode proximate an opening in a transparent bulb; electrically powering the light emitting diode with a driver disposed outside the transparent bulb; dissipating heat generated by the light emitting diode with a heat sink disposed outside the transparent bulb; collecting light emitted by the light emitting diode with a proximal end of a light pipe disposed inside the transparent bulb; transmitting the collected light to a distal end of the light pipe by transmission through the light pipe and by total internal reflection from a lateral edge of the light pipe; receiving the light from the distal end of the light pipe at a volume scattering element, the volume scattering element comprising a transparent base material and a plurality of particles distributed throughout the base material, each particle in the plurality being transparent and having a refractive index different from that of the base material; and scattering the received light into a plurality of directions with the volume scattering element.

An additional embodiment is a lamp, comprising: a transparent bulb having an opening; a light emitting diode disposed proximate the opening in the transparent bulb for emitting light into the transparent bulb; a heat sink proximate the light emitting diode and in thermal contact with the light emitting diode, the heat sink comprising a distal edge facing the light emitting diode and a lateral edge extending longitudinally proximally away from the distal edge around a circumference of the lamp, the lateral edge and distal edge forming an interior of the heat sink; a light emitting diode driver disposed within the interior of the heat sink for supplying electrical power to the light emitting diode; and an electrically conductive base extending proximally from the lamp for receiving electrical power from a socket and supplying electrical power to the light emitting diode driver, the base being thermally insulated from the heat sink.

### BRIEF DESCRIPTION OF THE SEVERAL VIEWS OF THE DRAWINGS

FIG. 1 is a plan drawing of a lamp.

FIG. 2 is an exploded-view drawing of the lamp of FIG. 1.

FIG. 3 is a side-view cross-section drawing of the assembled lamp of FIGS. 1 and 2.

FIG. 4 is an end-on view drawing of the lamp of FIGS. 1-3.

FIG. 5 is a close-up detail drawing of the lamp of FIGS. 1-4.

FIG. 6 is a side-view cross-section drawing of the secondary optics of the lamp of FIGS. 1-5.

FIG. 7 is a schematic drawing of the light leaving the light emitting diode and entering the proximal end of the light pipe, for the lamp of FIGS. 1-6.

FIG. 8 is a schematic drawing of the light propagating down an exemplary light pipe.

FIG. 9 is a schematic drawing of the light propagating down another exemplary light pipe.

FIG. 10 is a schematic drawing of the light propagating down a third exemplary light pipe.

FIG. 11 is a schematic drawing of an exemplary volume scattering element, with a detail showing a base material and various particles.

FIG. 12 is a schematic drawing of an exemplary light pipe and an exemplary volume scattering element.

FIG. 13 is a schematic drawing of another exemplary light pipe and another exemplary volume scattering element.

FIG. 14 is a schematic drawing of an exemplary light pipe made integral with an exemplary volume scattering element.

FIG. 15 is a schematic drawing of the light exiting the light pipe and entering the volume scattering element.

FIG. 16 is a schematic drawing of the light scattered from the volume scattering element, with proximal and distal directions.

FIG. 17 is a plot of simulated scattering versus direction, as a function of particle density and particle refractive index.

FIG. 18 is a plot of additional simulated scattering versus direction, as a function of the wavelength of light.

FIG. 19 is a schematic drawing of the “Dynasty B10 LED Candelabra Lamp”.

FIG. 20 is a reproduction of FIG. 34A of the known lamp of Chaves.

FIG. 21 is a reproduction of FIG. 7A of the known lamp of Mifiano.

### DETAILED DESCRIPTION OF THE INVENTION

A lamp having a candle-like appearance and using one or more light-emitting diodes (LEDs) as its light source is presented. The candle-like appearance arises because light is emitted from only a small volume at or near the center of the bulb. The heat sink and control electronics are located outside the bulb of the lamp. Inside the bulb is a set of secondary optics that guide the light from one or more LEDs to an emission point at a prescribed location in the interior of the bulb. The secondary optics include a light pipe that guides light away from the LED chip, and a volume scattering element that receives the light from the light pipe and scatters it into various directions. The volume scattering element is made from a transparent base material, and includes transparent particles of a predetermined size and refractive index. Because the lamp is typically used in an overhead position, such as in a hanging chandelier, the density of particles in the volume scattering element, the particle size and the particle refractive index are chosen to produce a scattering pattern that directs more light downward (toward the base of the bulb) than upward, while maintaining a reasonable efficiency (fraction of produced light that successfully exits the lamp). Simulation results are presented.

The above paragraph is merely a summary, and should not be construed as limiting in any way. Additional description is provided in the text and figures below.

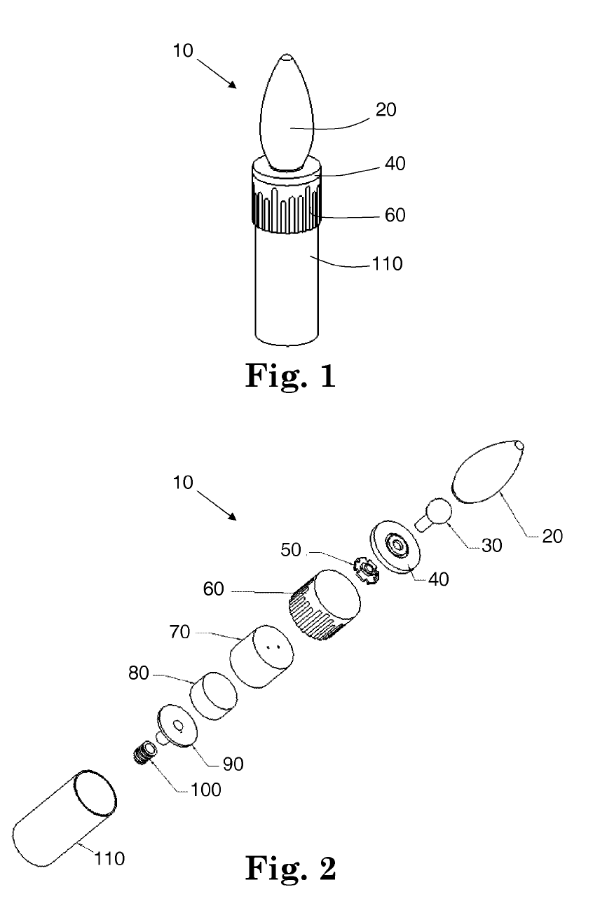

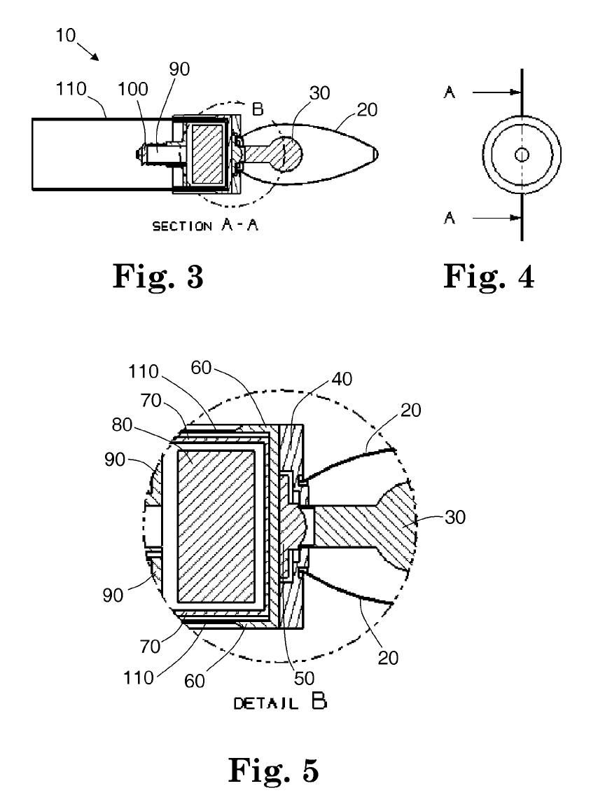

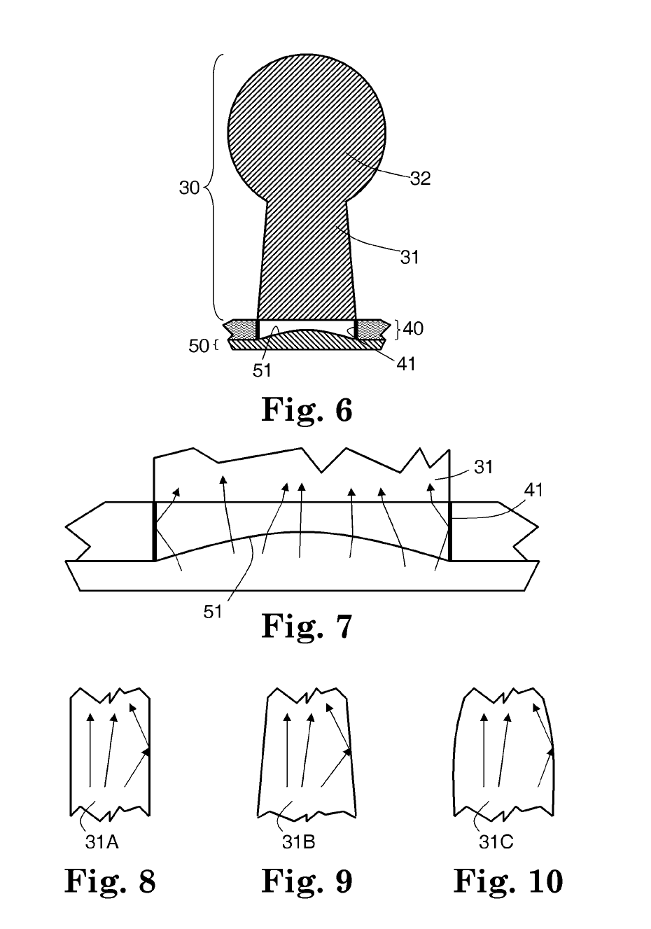

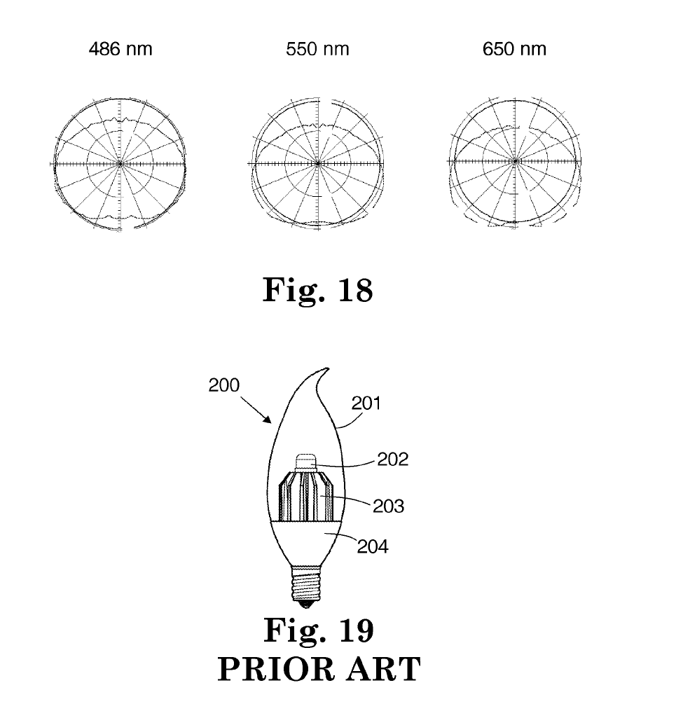

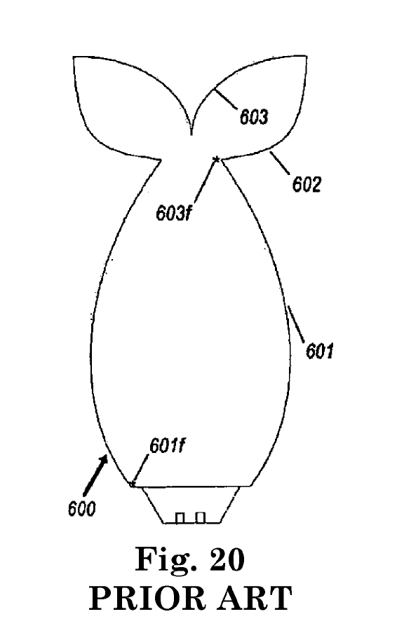

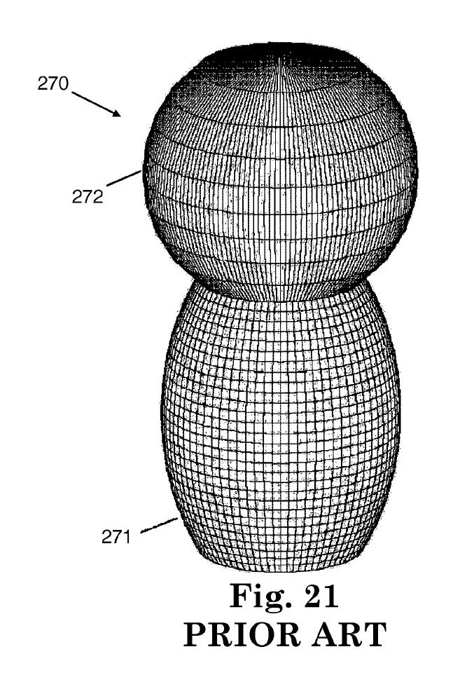

The remainder of this document is divided roughly into three sections. The first section, covering FIGS. 1 through 5, describes the structural elements of the lamp. The second section, covering FIGS. 6 through 16, describes the optical path of the lamp, from the LED, through the light pipe, to the volume scattering element, and eventually out of the lamp. The third section, covering FIGS. 17 and 18, describe the optical modeling and simulations of the optical path.

We begin with a description of the structural elements of an exemplary lamp 10, shown in various views in FIGS. 1 through 5. More specifically, FIGS. 1 through 5 are a plan drawing, an exploded-view drawing, a side-view cross-section drawing, an end-on view drawing and a close-up detail drawing, respectively, of the lamp 10. The lamp 10 is described below in conjunction with all five figures. Our description will proceed from right-to-left in FIG. 2.

The bulb 20 is a transparent bulb made from glass or plastic, with a hollow interior and an opening at one longitudinal end. The bulb may be any suitable size and shape.

In some applications, the bulb is a so-called “B-10” bulb. The “B-10” describes a particular bulb shape, known in the industry and widely commercially available in existing decorative light bulbs. The “B-10” shape is elongated or torpedo-shaped, with relatively small longitudinal ends and a relatively wide central portion. The bulb shape itself somewhat resembles the shape of a candle flame. The transverse diameter of a B-10 bulb is 1.25 inches, or 32 mm.

The secondary optics 30 extend into the interior of the bulb 20 when assembled. The secondary optics 30 include a light pipe 31 and a volume scattering element, both of which are described in more detail in the next section below.

An optic mount 40 serves both as a mount to mechanically secure the secondary optics 30 in place, and as a cover for the LED package. In some applications, the light pipe 31 is spaced apart from the LED package by an air gap, so that the heat generated by the LED chip is largely kept away from the secondary optics. In these applications, the optic mount 40 may act as a spacer between the LED package and the secondary optics 40. The optic mount 40 may be made from any suitable metal or plastic material, such as brass, aluminum or steel.

In some applications, the optic mount 40 includes a reflective cylindrical inner surface 41, which reflects high-exiting-angle light emitted from the LED and reflects it back toward the proximal face of the light pipe 31. The reflective surface may be molded to its smooth finish, or may be polished to its smooth finish. The reflective surface may optionally include one or more reflective thin films that increase its reflectivity.

The LED package 50 includes the LED chip itself, which is the area that emits light, and the mechanical package that supports the LED chip. In some applications, the LED package includes one or more lenses over the LED chip, which can protect the chip and may optionally alter the angular light output from the chip.

It is intended that any of a number of commercially available LED packages may be used in the lamp 10. As a specific example, one style of package that may be used is sold under the name OSTAR, which is a registered trademark of Osram Opto Semiconductors. The Ostar LEDs are commercially available from Osram Opto Semiconductors.

Ostar Lighting LEDs may have an emission color of “white”, which has color coordinates (x,y) of (0.33, 0.33), or “warm white”, which has color coordinates of (0.42, 0.4). Ostar Lighting LEDs typically have an array of LED chips, rather than a single chip. The array layout may be 2-by-2 or 2-by-3 chips, with full array extending over a rectangular area of about 2.31 mm by 1.9 mm. Ostar Lighting LEDs may have an optional lens over the chip array. Ostar Lighting LEDs may have an angular output described by a full-width-at-half-maximum (FWHM) of 120 degrees for the un-lensed LEDs and either 120 or 130 degrees for the lensed LEDs.

These Ostar LEDs are phosphor based, meaning that the actual LED chips themselves emit relatively short-wavelength light, typically in the blue, violet or UV portions of the spectrum. A phosphor absorbs the short-wavelength light and emits longer-wavelength light into a desired spectrum. The precise characteristics of the spectrum, such as width, flatness and so forth, are determined largely by the chemistry of the phosphor and its interaction with the short-wavelength light. For lighting applications, it is generally desirable that the human eye perceives the lamp-emitted light as being roughly “white”, which has a color coordinate (x,y) of (1/3, 1/3).

The mechanical package of the Ostar Lighting LEDs is generally hexagonal, in the plane of the package, with indentations at the six corners that can accommodate a screw head. Other suitable package shapes may also be used.

The Ostar Lighting LEDs include pads that electrically connect to the chip, but do not include the driver circuitry to control the current to the LEDs. The circuitry is included with the LED driver 80, and is described below.

The LED package 50 produces heat, which is dissipated and directed away from the LED package by a heat sink 60. The heat sink 60 is made from a thermally conductive metal, such as aluminum, although any suitable material may be used.

The heat sink 60 includes a distal-facing face that is generally flush with the proximal side of the LED package 50 and is in good thermal contact with the LED package 50. The distal-facing face may include one or more screw holes and/or one or more holes that accommodate an electrical connection to the LED package 50.

The heat sink 60 is generally shaped as a shell, having a generally solid distal face in contact with the LED chip, having generally solid transverse-facing walls, and having a hollow interior, with no bounding proximal-facing wall. It is desirable that the exterior portion of the heat sink 60 have as large a surface area as possible, so the heat sink may include a striped pattern or “fins” that increase its surface area. In some applications, the heat sink 60 may also include cosmetic features, such as decorative stripes, possibly of varying length around the circumference of the heat sink. Optionally, the heat sink may include features that resemble wax dripping from the top of a candle. In some applications, the heat sink may includes holes in its surface.

Because the heat sink 60 may be metallic, and therefore electrically conducting, it is desirable to electrically insulate the LED driver from the heat sink 60. Therefore, a driver insulator 70 is disposed within most or all of the interior of the heat sink. The driver insulator 70 may be made from any suitable non-conducting material, such as plastic. Optionally, the driver insulator 70 should be able to withstand slightly elevated temperatures, such as those experienced by the heat sink 60. The driver insulator 70 is also generally hollow, with no proximal-facing wall.

The LED driver 80 is disposed within the driver insulator 70, which in turn resides within the heat sink 60. Such LED drivers 80 supply a prescribed amount to the LED chip, and may include circuitry that that takes line voltage, such as 120 volts or 240 volts AC, and converts it to a much lower voltage, such as 5 volts DC. The LED driver 80 may include filtering circuitry that can ensure the LED chips against damage from fluctuations in the line voltage. A typical current level for the Ostar Lighting LEDs described above is 350 milliamps, although any suitable current level may also be used.

The LED driver 80 may have two or more electrical leads that extend through holes in the driver insulator 70 and the heat sink 60 to the LED package 50.

On the proximal side of the LED driver 80 is a base insulator 90, which serves a similar function as the driver insulator 70. The base insulator may include one or more holes that can accommodate electrical connections to the base, for receiving the line voltage. The base insulator 90 may be made from any suitable material, such as plastic.

The base 100 is a male threaded portion that interfaces with a socket. Typically, the threads are for one electrical connection to the line voltage, with the longitudinal end (the proximal-most end) of the base 100 being for the other electrical connection.

The lamp may be available in any suitable thread size. Two common thread sizes are candelabra (E12) or medium (E26), which have a diameter at the thread peaks of 12 mm and 26 mm, respectively.

When assembled, the lamp 10 will include as a single unit all the elements from the bulb 20 to the base 100. In FIG. 1, all elements but 110 are included as the single unit, with the threaded base 100 extending from the proximal end of the unit.

Element 110 is a telescoping extension tube that is typically part of the socket fixture, rather than part of the lamp unit (elements 20 through 100). The tube 110 is hollow, and generally drops into place under the influence of gravity. The tube 110 may have any desired length, and may be cosmetically designed to look like a candle or candlestick. The extension tube may be made from plastic, metal, or any suitable material, and may optionally be white or light-colored to provide a dignified, stylish appearance to the lamp 10.

The extension tube 110 is typically considered part of the socket holder. The socket itself, not shown in the figures, includes the female threads that match the male threads of the base 100. In some applications, the base 100 and socket use non-threaded plug-in connectors, rather than screw-in threads.

The above section describes the structural elements of the lamp 10. The following section describes the optical path in the lamp 10. In particular, there is a detailed description of the secondary optics 30 that are mentioned briefly in the previous section.

FIG. 6 is a side-view cross-section drawing of the secondary optics 30 of the lamp of FIGS. 1-5.

The secondary optics 30 include a light pipe 31 that transmits light from an exiting surface 51 of the LED package 50 to a volume scattering element 32. To the viewer, there is little or no emission from the light pipe 31, and all or nearly all of the light from the lamp 10 appears to radiate from the volume scattering element 32.

Such a volume scattering element 32 is significantly smaller than the full bulb 20. Because the light appears to come from a relatively small area or volume in the middle of the bulb, the lamp 10 may be more aesthetically pleasing than a lamp in which the whole bulb area emits light, such as a frosted bulb, or a compact fluorescent lamp with a frosted bulb. The relatively small area of the volume scattering element provides a “twinkle” of the light for the viewer, which is a desirable feature and is quite stylish. This “twinkle” arises from the relatively small emission area inside the bulb, and is analogous to the “twinkle” of a star in the sky. In many cases, a frosted bulb, which may have light radiating from its entire surface area, may not exhibit such a pleasing “twinkle”.

Each feature in the secondary optics is described sequentially, as we trace the optical path from the LED, through the light pipe, to the volume scattering element, and out of the bulb.

FIG. 7 is a schematic drawing of the light leaving an exiting surface 51 the light emitting diode package 50 and entering the proximal end of the light pipe 31, for the lamp of FIGS. 1-6.

Light leaves the exiting surface 51 of the LED package 50 with a particular angular profile. In many cases, the angular profile is Lambertian, which has a cosine dependence of power versus propagation angle. The most (peak) power is radiated perpendicular to the plane of the LED, and the angular falloff from such a Lambertian distribution varies as the cosine between the surface normal and the angle of the propagating ray. The Lambertian distribution has a full-width-at-half-maximum (FWHM) of 2 cos ⁻¹ (0.5), or 120 degrees. In other words, the optical power propagating at 60 degrees away from the surface normal is half of the optical power propagating parallel to the surface normal. The angular distribution falls to zero at 90 degrees, so there is effectively no optical power propagating parallel to the face of the LED. In general, the angular profile of the LED package is the same at all emitting locations in the LED array, although this is not required.

FIG. 7 shows a variety of light rays leaving the LED package 50. The LED package is drawn as having a curved exiting face 51, which corresponds to a lensed LED package, although this is not required. A flat exiting face may also be used. The rays refract upon exiting the lens in the LED package, going from a higher refractive index, on the order of 1.5, to a lower refractive index of 1, corresponding to free-space propagation.

Most rays exit the LED package, propagate through free space, then enter a proximal surface of the light pipe 31. Some high-angle rays first strike the reflective sides 41 of the optic mount, and reflect back toward the proximal surface of the light pipe 31.

The proximal surface of the light pipe 31 is drawn as being flat, although it may optionally be curved. If the proximal surface is flat, the light pipe 31 will be less sensitive to misalignment with respect to the LED package than if the surface is curved. Such a decrease in sensitivity may be desirable, as it tends to relax some of the alignment tolerances and therefore improve yields in the assembly process.

The proximal surface may optionally include a dielectric thin film coating that reduces reflections from the surface; the dielectric coating may be a single layer, or may be multilayer. Such anti-reflection coatings are well known in the industry, and may include a quarter-wave coating (a “V” coat), a “W” coat, or a more complicated structure.

Once inside the light pipe 31, light rays travel from the proximal end, near the LED, to the distal end, near the volume scattering element. Most of the light rays travel simply by propagating longitudinally along the light pipe or at a slight incline to a longitudinal axis of the light pipe. Some higher-angle rays reflect off the lateral side or lateral sides of the light pipe. Such a reflection occurs at an angle of incidence greater than the critical angle within the light pipe, and is total internal reflection. For total internal reflection, there is no light transmitted through the lateral side of the light pipe, and from the outside of the bulb, no light is seen leaving through the lateral side of the light pipe.

In some cases, the light pipe 31 is made from polymethyl methacrylate (PMMA), which has a refractive index of about 1.49 at a wavelength of 550 nm. Such a material is relatively inexpensive, relatively durable, and is moldable, so that the light pipe 31 may be molded. In other cases, other materials may be used, such as glass or another form of plastic.

In some cases, the light pipe 31 may include scattering elements, in addition to the scattering elements in the volume scattering element 32. The optional scattering elements in the light pipe 31 may be similar in construction to those in the volume scattering element 32, such as small particles of a slightly different refractive index than the base material of the light pipe 31. Any or all of the particle refractive index, size distribution and density may all be the same or different, compared with the particles in the volume scattering element 32.

The light pipe 31 is largely cylindrical in shape, with a pronounced longitudinal shape. FIGS. 8, 9 and 10 show several possibilities for this largely cylindrical shape. In FIG. 8, light pipe 31A is truly cylindrical, with circular cross-sections, taken parallel to a longitudinal axis of the light pipe. Because the light pipe is truly a cylinder, these circular cross-sections have the same size everywhere between the proximal and distal ends of the light pipe 31A. In FIG. 9, light pipe 31B is slightly conical, so that the circular cross-sections decrease in size from the proximal to the distal end of the light pipe 31B. The size of the circles vary linearly with distance along the light pipe 31B. In FIG. 10, light pipe 31C also has circular cross-sections that decrease in size from the proximal to the distal end of the light pipe 31C, but the size of the circles varies other than linearly with distance along the light pipe 31C. In other words, for a slice that includes a longitudinal axis of the light pipe, light pipes 31A and 31B have straight sides, and light pipe 31C has tapered sides. Specifically, the shape of light pipe 31C may be referred to as tapered outwards. The tapering may be any suitable shape, as long as total internal reflection is maintained inside the light pipe 31.

Alternatively, the light pipe need not have true rotational symmetry about its longitudinal axis. The light pipe may be elongated in one direction or the other, may have tapering in one direction or not the other, or may have different tapering in different directions. For all of these, the cross-sections may ovals, ellipses, or other elongated shapes.

In some cases, the light pipe may optionally have more complicated shapes, such as a helix, which can optionally cause light to exit the light pipe in prescribed locations. For instance, the light pipe may have a decorative stripe on its outer surface, which may be a scratch, groove, indentation or protrusion, along which some light leaves the light pipe. Alternatively, there may be smaller features, like dots or stars, which can emit light along the lateral edge of the light pipe.

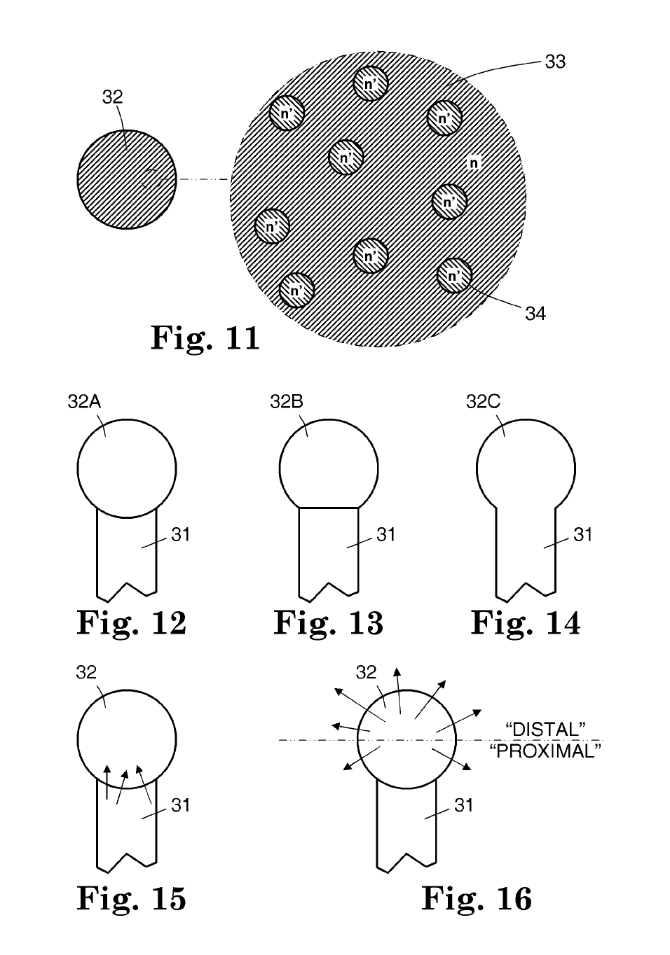

Light proceeds longitudinally down the light pipe 31 and enters the volume scattering element 32. The internal structure of the volume scattering element 32 is shown schematically in FIG. 11.

The volume scattering element 32 includes a transparent base material 33 that has a refractive index n. The base material 33 has a collection of particles 34 mixed into it, where the particles have a prescribed size, a prescribed shape, and a refractive index n′ that differs slightly from the refractive index n of the base material 33. In many cases, the prescribed shape is round, or as round as possible with typical manufacturing techniques. In many cases, the size of all the particles is the same, or is as close as possible to a particular desired size. For instance, the particles may have a diameter in the range of 3 microns +/−0.1 microns. The range may represent cutoff points, so that the distribution of the diameters is roughly uniform in the range of 2.9 to 3.1 microns. Alternatively, the range may represent width points in a distribution. For instance, a particular manufacturing process may produce a normal (Gaussian) distribution of diameters, with a mean value 3.0 microns and a standard deviation of 0.1 microns. The other width points may be a full-width-at-half-maximum (FWHM), a 1/e half- or fullwidth, a 1/e² half- or full-width, an interquartile range, and so forth.

For the cases above, there is a deliberate attempt to make the particles have the same size, to within reasonable manufacturing tolerances. In other cases, there is a deliberate attempt to use more than one particle size. Such a diameter distribution may include one or more discrete sizes, and may also include a distribution of sizes centered around a particular size. In still other cases, there may be a distribution of particle refractive indices, as well as an optional distribution in particle sizes. For the simulations performed below, it is assumed that the particles are all round, all have diameters that form a particular distribution, and are uniformly distributed throughout the base material with a particular particle density.

Although the volume scattering element is drawn in FIG. 11 as being spherical or ball-shaped, it may also be one of many other shapes, including a partial sphere, a half-sphere, a half-sphere with the flat side facing downward, a mushroom shape, ellipsoidal, an elongated ellipse, a cube, a plate, a pyramid, an oblate spheroid, soccer-ball shaped, or any other suitable shape. In general, the shape of the volume scattering element is far less critical than the shapes of the beam-shaping elements discussed in the above background section, because of the nature of the light propagation within the volume scattering element. This is explained in the following three paragraphs.

For the purely refractive and surface diffuser structures discussed in the background section, the light rays follow a deterministic path from the LED package, through a relatively small number of refractions and/or reflections, to a particular location on the surface of the structure. In this case, a “small” number of refractions and/or reflections may number or the order of 5, 10, 50 or 100, which is easily simulated with deterministic raytracing software. The performance of these structures is highly dependent on the actual shape of the structures. For instance, there are many exotic element shapes disclosed by the Chaves reference, with seemingly tiny changes in shape causing surprisingly large changes in performance. It is clear that the Chaves elements will have extremely tight manufacturing and alignment tolerances. In general, these tight tolerances are characteristic of light redirection structures that rely only on deterministic ray propagation inside the structure. A surface diffuser may randomize each ray direction as it exits the structure, but it does not change the location on the structure at which each ray exits, and does little to reduce the generally tight tolerances.

In contrast, a volume scattering element begins to redirect rays as soon as they enter the element, rather than only redirecting them as they exit the element. Because there may be millions of particles within the element, there may be thousands or even millions of ray redirections between when a ray enters and when a ray finally exits the element. These redirections are most easily treated by a stochastic, or probability-based analysis, rather than a truly deterministic raytrace. Fortunately, many raytracing software packages can perform these probability-based calculations within the framework of a conventional raytrace, so that a deterministic raytrace is performed for rays outside the volume scattering element and a probability-based calculation treats the ray performance inside the volume scattering element.

Because the volume scattering element performs ray redirection in its entire volume, rather than just at its surface, it has far more relaxed tolerances on its surface profile than the Chaves elements discussed above. For example, if one particular location on the surface of the volume scattering element is misshapen, there may be little or no effect on the exiting light distribution, simply because on average, each ray would receive only a tiny fraction of its redirection from the misshapen portion.

In some cases, the base material 33 of the volume scattering element 32 is PMMA, which may be the same material as the light pipe 31. In that case, because the materials are the same, the refractive indices are the same, and there is no reflection that arises at the interface between the light pipe 31 and the volume scattering element 32. In other cases, different materials may be used for the volume scattering element and the light pipe.

In some cases, the particles are made from a material having a refractive index in the range of about 1.51 to about 1.59 at a wavelength of 550 nm. For a typical base material of PMMA, which has a refractive index of about 1.49 at a wavelength of 550 nm, the difference in refractive index between the particles and the base material is typically in the range of about 0.05 to 0.06, although the difference may also lie outside this range. The particles typically have sizes (diameters) in the range of about 1 micron to about 10 microns. The particles may be generally considered round; simulations using an assumption that the particles are round have produced results consistent with measured quantities.

Note that in some cases, the base material 33 is transparent, meaning that there is no absorption by the base material, and the particles 34 are also transparent. In other cases, one or both materials may absorb slightly.

In some cases, the volume scattering element 32 may include phosphor particles mixed within the interior of the scatterer. Such phosphor particles may absorb relatively short-wavelength light from the LED and may radiate phosphor-emitted light from their respective locations within the interior of the scatterer. By locating the phosphor within the scatterer, one may use a short-wavelength LED, such as a blue LED, rather than a white-light LED that includes its phosphor as part of the LED package.

Alternatively, one may include a phosphor mixed within the scatterer, in addition to the phosphor in the LED package. Such a phosphor may be use to tweak or adjust the color rendering of the lamp, or adjust the color temperature of the lamp. For instance, one particular phosphor may radiate mainly in the red portion of the spectrum, so that the addition of this red phosphor into the interior of the scatterer may add a reddish tinge to the lamp output. Other examples are certainly possible.

As a further alternative, a phosphor may be applied to the outside of the scattering element 32, in addition to or instead of the LED package phosphor and/or the phosphor in the interior of the volume scatterer 32. This phosphor may be applied as a film, rather than as discrete particles within a particular volume.

As a still further alternative, an optional reflector may be applied to the top (distal end) of the volume scattering element 32. Such a reflector may be completely or partially reflective, and may be applied as a metallic or a dielectric film on the distalmost surface of the scatterer. This optional reflector would reduce emission in the distal direction, and would redirect the light back into the scatterer volume in the proximal direction. In some cases, the reflector may be rotationally symmetric around the longitudinal axis of the scatterer 32. In some cases, the reflector may cover an entire hemisphere of the scatterer 32. In other cases, the reflector may cover only a portion of the distal half of the scatterer 32. In some cases, the reflector may have a variable thickness (or reflectivity), being thickest (or most reflective) at the distalmost point on the surface, and decreasing away from the distalmost point.

When light passes through a material that includes lots of small particles, it undergoes scattering caused by the many small reflections and refractions that arise at the surface of each particle. The scattering may be given a variety of names, such as Mie scattering, Rayleigh scattering, and so forth. Without specifically considering the particle size and wavelength range in which each term strictly applies, it is sufficient to state the physics of the volume scattering element as follows. A light ray enters the volume scattering element and strikes a particle. A large fraction of the power is transmitted through the particle then exits the particle, with a slight change in direction at the incident and exiting faces of the particle due to refraction. At the incident and exiting faces, a small fraction if the power is reflected. These reflected and refracted rays then strike other particles, and the process repeats. Eventually, after interacting with many, many particles (i.e. refracting and reflecting), the light rays leave the volume scattering element, with a direction that can be determined statistically. In other words, for a given input direction, there is an exiting distribution as a function of angle. Such a distribution can be determined analytically (generally very difficult) or by a probability-based routine embedded within a raytracing program (generally much simpler). The simulations that go into the exiting distributions are discussed in the following section.

The interface between the light pipe 31 and volume scattering element 32 may take on any one of a variety of shapes. For instance, FIG. 12 shows a volume scattering element 32A that is a true sphere, with the light pipe 31 including a concave depression at its distal end that matches the curvature of the sphere. FIG. 13 shows a volume scattering element 32B that has a flat portion removed from its proximal side, so that the adjoining light pipe 31 may have a flat distal end. Alternatively, FIG. 14 shows a volume scattering element 32C made integral with the light pipe 31. As a practical matter, the differences among the cases of FIGS. 12, 13 and 14 show up in where in the volume scatterer the particles 34 actually reside; if there is a portion of the sphere that lacks particles 34, it is easily handled in the simulation of the optical system.

In some cases, the distal end of the light pipe is flat, and a corresponding portion of the volume scattering element is polished or molded to also be flat. The flat portions of the light pipe and volume scattering element may then be attached to each other using optical contacting, optical adhesives such as UV-cured or thermal adhesives, local ultra-sonic melting and attachment of the plastic parts, or any other suitable attachment method. In other cases, the light pipe and volume scattering element may be manufactured as a single integral part, rather than as separate parts that are later attached. For instance, one of the parts may be molded, and the other of the parts may be then molded in an adjacent portion in the same mold.

FIG. 15 shows light leaving the light pipe 31 and entering the volume scattering element 32. Note that in some cases, the refractive indices are the same in both elements, so that there is no reflection at the interface and no bending of the rays at the interface.

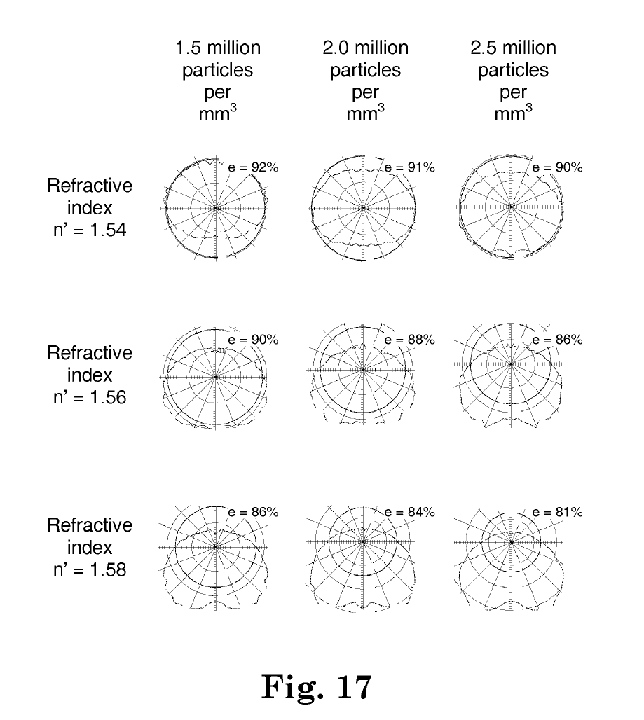

FIG. 16 shows the exiting rays as they leave the volume scattering element 32. They may be roughly divided into rays propagating in the “distal” and “proximal” directions, the dividing line being perpendicular to a longitudinal axis of the light pipe 31. Light scatters into essentially the full half-spaces of the “distal” and “proximal” directions, with a statistical analysis determining how much light propagates into each direction. Such a statistical analysis is performed in the following section.

Having completed our description of the secondary optics 30, we turn to the computer modeling and simulations of the optical path in the lamp 10.

The following description is intended to provide an example of the type of simulation that may be performed by one of ordinary skill in the art. The simulation is for one specific configuration of the lamp 10, and is not intended to be limiting in any way. Other configurations may be modeled in a similar manner. The following paragraph describes the specific optical system that is simulated in the plots of FIG. 17.

The LED package is an Ostar Lighting LED array, with an emission area of 2.31 by 1.9 mm. The LED is assumed to be essentially at the proximal face of the light pipe, so that all the LED-emitted light enters the light pipe. The light pipe itself has a length of 0.5 inches (12.7 mm) and a diameter of 8 mm, and is made from PMMA, with a refractive index of 1.49 at 550 nm. The volume scattering element is also made from PMMA, with a particle diameter of 3 microns. Two quantities are allowed to vary from calculation to calculation: the refractive index of the particles and the particle density. For each combination of these quantities, an angular plot is generated, and an efficiency is calculated. The results are averaged over several wavelengths, which correspond to the emission spectrum of the LEDs.

The angular plot represents the amount of power directed into a particular angle. Using the sign convention of FIG. 16, the “distal” direction is up in the plots of FIG. 17, and the “proximal” direction is down.

The efficiency is a single number between 0% and 100%, which represents the amount of light exiting the bulb, divided by the amount of light emitted by the LED array. The difference between the reported efficiency and the full 100% represents the fraction of light that is scattered back into the light pipe or is blocked by the mechanical objects past the proximal end of the lamp, such as the heat sink. A higher efficiency number is preferred.

Before specifically addressing the cases that were actually modeled, it is worthwhile to consider some extreme values of the refractive index and particle density.

For a refractive index that approaches 1.49, we expect to see the effects of scattering largely disappear, since the particles become effectively invisible inside the base material. This should result in all or most of the light being directed in the distal direction (upward in the plots), and essentially nothing being directed in the proximal direction (downward in the plots). This trend should also follow for the particle density being set to zero—the scattering disappears, and nearly all the light travels upward. For these two extreme cases, there is still an angular distribution about the “180 degree” point at the top of the plots, which arises from propagation through the light pipe and reflections off the lateral side of the light pipe. The efficiency of such an extreme case should be 100%, since no light is blocked at any point in the optical system.

At the other extreme, we may increase the particle density and/or increase the refractive index of the particles to an arbitrarily large value. This should give a mirror-like quality to the volume scattering element, which would produce more proximal (downward) light than distal (upward). The efficiency of such a system should be significantly less than 100%, since a great deal of light may be blocked by the heat sink, the light pipe, or other elements that lie downstream from the bulb, in the proximal direction.

In practice, we want slightly more downward light than upward, since these lamps are typically mounted in hanging or decorative chandeliers above eye level. We don't want all of the light directed downward, or a 50/50 split between upward and downward, but just slightly more downward than upward, so that more light is directed to the viewer and not to the ceiling of the room. We also want a reasonable efficiency, which directly affects the perceived brightness of the lamp.

The above-described system was entered into LightTools, a raytracing program that is commercially available from Optical Research Associates, based in Pasadena, Ca. Other raytracing programs may also be used, including ASAP, Code V, Oslo, Zemax, or any other commercially available or homemade raytracing program.

Nine different simulation runs were performed, and the results are shown in the nine plots of FIG. 17. For each plot, there is a jagged curve that surrounds the origin, representing Longitudinal, 180 degrees. This curve is the angular plot of interest, and represents the angular output in the plane of the page, with the sign convention shown in FIG. 16. The top-left plot, for a refractive index of 1.54 and a particle density of 1.5 million per cubic mm, shows a plot in which more light is directed upward than downward. The bottom-right plot, for 1.58 and 2.5 million particles per cubic mm, shows more light being directed downward than upward.

There is also a nearly circular curve on all nine plots, representing Lateral, 90 degrees, which gives angular results for a slice out of the page, perpendicular to the longitudinal axis of the light pipe. We expect this curve to be nearly circular, since our optical system is symmetric about the longitudinal axis and we don't expect significant variation in this direction.

The “efficiency” numbers are superimposed over each graph, with variations from 92% down to 81%.

Overall, it is determined that the center and middle-left plots are the most desirable of the nine cases studied. This corresponds to a refractive index of 1.56 and a particle density in the range of about 1.5 million to 2.0 million particles per cubic millimeter. This produces more downward-traveling light than upward, with an efficiency in the range of about 88% to about 90%.

The results are for a particular geometry, including a particular light pipe and volume scattering element geometry, and a single particle size. The calculations may be repeated as necessary for a different geometry, different particle size, or different volume scattering element base material.

As mentioned above, the plots of FIG. 17 are weighted averages of the performance of one or more wavelengths. For instance, the LED output may have red, green and blue contributions, and the calculations may be a weighted average of the red, green and blue light, each being traced through the optical system.

FIG. 18 is a plot of the performance of one particular configuration, at three different wavelengths. The leftmost plot is for blue light, with a wavelength of 486 nm, the center plot is for green light at 550 nm, and the right plot is for red light at 650 nm. In reality, the white light from the LED array may include a continuous and/or discrete spectrum that includes the region of 486 nm to 650 nm, and the three chosen wavelengths may roughly represent this spectrum.

We see that the blue light has more upward-propagating power than the red light, and less downward propagating power than the red light. In other words, for viewers that are directly beneath the lamp, or close to the base of the lamp, the lamp should have more of a reddish tint, when compared with a view from far away from the base of the lamp. Likewise, light that reaches the ceiling will have a more bluish tint than light directed downward.

For this particular case in FIG. 18, the calculations were performed using a particle refractive index that was taken to be constant for all three wavelengths. In practice, the refractive index of the particle varies with wavelength, as does the refractive index of the base material. Such a refractive index variation with wavelength is known as dispersion, and virtually all optical materials have well-documented values of dispersion. The effects of dispersion may easily be incorporated into the calculations, although they were deliberately omitted from the plots of FIG. 18 to highlight the wavelength-dependent scattering effects.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

We claim:

1. A lamp (10), comprising:
a transparent bulb (20) having an opening;
a light emitting diode (50) disposed proximate the opening in the transparent bulb (20) for emitting light into the transparent bulb (20);
a heat sink (60) proximate the light emitting diode (50) and in thermal contact with the light emitting diode (50), the heat sink (60) comprising a distal edge facing the light emitting diode (50) and a lateral edge extending longitudinally proximally away from the distal edge around a circumference of the lamp (10), the lateral edge and distal edge forming an interior of the heat sink (60);
a light emitting diode driver (80) disposed within the interior of the heat sink (60) for supplying electrical power to the light emitting diode (50); and
an electrically conductive base (100) extending proximally from the lamp (10) for receiving electrical power from a socket and supplying electrical power to the light emitting diode driver (80), the base (100) being thermally insulated from the heat sink (60).

2. The lamp (10) of claim 1, further comprising:
a driver insulator (70) surrounding the light emitting diode driver (80) on its distal and transverse sides and being surrounded by the heat sink (60) on its distal and transverse sides; and
a base insulator (90) proximate a proximal side of the light emitting diode driver (80);
wherein the base insulator (90) thermally insulates the base (100) from both the heat sink (60) and the light emitting diode driver (80).

3. The lamp (10) of claim 2, wherein the heat sink (60) radially surrounds a portion of a telescoping extension tube (110); and
wherein the telescoping extension tube (110) radially surrounds a portion of the driver insulator (70).

4. The lamp (10) of claim 1, wherein the heat sink (60) forms an exterior shell around the transverse circumference of the lamp (10) between the bulb (20) and the base (100).

5. The lamp (10) of claim 1, wherein the heat sink (60) has an appearance that resembles dripping candle wax.
